(19) United States
(12) Patent Application Publication
(10) Pub. No.: US 2019/0143624 A1
(43) Pub. Date: May 16, 2019

(54) DOWNHOLDING PRESS FOR PRODUCING A SEMI-FINISHED PRODUCT FROM SHEET-METAL MATERIAL HAVING THICKNESS-REDUCED REGIONS, AND METHOD FOR PRODUCING A SHEET-METAL FORMED PART

(71) Applicant: BENTELER AUTOMOBILTECHNIK GMBH, Paderborn (DE)

(72) Inventors: Erik HOCHAPFEL, Gudensberg (DE); Thomas HENKSMEIER, Wadersloh (DE)

(21) Appl. No.: 16/111,515

(22) Filed: Nov. 13, 2018

(30) Foreign Application Priority Data
Sep. 1, 2017 (DE) 102017120192.0

(51) Int. Cl. B30B 1/26; B21D 11/10; B21D 11/20; B21D 11/22

(52) U.S. Cl. CPC B30B 1/261; B21D 11/10; B21D 11/08; B21D 11/22; B21D 11/203

(57) ABSTRACT

The disclosure relates to a downholding press for producing a semi-finished product from sheet-metal material having thickness-reduced regions, wherein the semi-finished product after forming has regions with mutually dissimilar wall thicknesses and the downholding press has an upper tool and a lower tool as well as a downholding element, and a convexity on the sheet-metal material is generated between the upper tool and the lower tool such that the sheet-metal material is reduced in thickness in regions by elongation, wherein a blocking cam is configured on the downholding element in such a manner that a follow-on of the sheet-metal material is impeded.

### RELATED APPLICATIONS

The present application claims priority of German Application Number 10 2017 120 192.0 filed Sep. 1, 2017, the disclosure of which is hereby incorporated by reference herein in its entirety.

### FIELD

The disclosure relates to a downholding press for producing a semi-finished product from sheet-metal material having thickness-reduced regions.

The disclosure furthermore relates to a method for producing a sheet-metal formed part having mutually dissimilar wall thicknesses.

### BACKGROUND

The production of motor vehicle components is well known from the prior art for metal sheets to be formed. To this end, metal sheets from steel alloys but also metal sheets from light-metal alloys are used.

The forming method is performed in such a manner that the sheet-metal material is provided in the form of a blank having a consistent wall thickness and is formed to the desired sheet-metal formed part. Such sheet-metal formed parts in the automotive sector, consequently motor vehicle components, are for example longitudinal beams, cross beams, crash boxes, or other structural body components. Axle components such as, for example, arms, axle sub frames, or similar, can also be produced by means of such forming methods.

In order for the omission of CO₂ to be reduced or for crash properties to be improved while simultaneously improving the properties of driving dynamics, the implementation of light construction measures is required.

Sheet-metal formed parts for motor vehicles are dimensioned in such a manner that said sheet-metal formed parts have an ideally low deadweight while having sufficient rigidity properties as required. To this end, tailored formed blanks are known from the prior art. Blanks which have mutually dissimilar wall thicknesses and/or dissimilar material properties are thus provided. For example, two metal sheets having mutually dissimilar wall thicknesses are welded together and subsequently formed to the sheet-metal formed part. A blank can also be partially rolled and subsequently be formed to the motor vehicle component.

A method for producing a sheet-metal formed part having mutually dissimilar wall thicknesses in regions, in which a convexity on a sheet-metal material having initially a consistent wall thickness is generated in a downholding press, is furthermore known from DE 10 2015 103 721 B3. This convexity elongates the sheet-metal material in a localized manner. The sheet-metal material in terms of the wall thickness thereof is thus reduced in the elongated region. After the sheet-metal material having the convexity is subsequently straightened, a semi-finished product or a blank, respectively, which has mutually dissimilar wall thicknesses is thus provided. Further forming to the sheet-metal formed part can then be carried out subsequent thereto.

The advantage of this method is that as opposed to, for example, the case of localized rolling of the blank in which the rolling process has to be carried out across the entire width of the blank, a region can be elongated in a targeted manner by localized elongation, for example in an inner region of the blank.

The entire content of the aforementioned publication is incorporated in this document by way of reference.

### SUMMARY

It is an object of at least one embodiment of the disclosure to further improve a downholding press for producing a semi-finished product and a method for producing a sheet-metal formed part.

The aforementioned object is achieved by a downholding press for producing a semi-finished product from sheet-metal material having thickness-reduced regions, wherein the semi-finished product after forming has regions with mutually dissimilar wall thicknesses and the downholding press has an upper tool and a lower tool as well as a downholding element, and a convexity on the sheet-metal material is generated between the upper tool and the lower tool such that the sheet-metal material is reduced in thickness in regions by elongation. A blocking cam is configured on the downholding element in such a manner that a follow-on of the sheet-metal material is suppressed. The aspect of the object in terms of method technology is furthermore achieved by a method for producing a sheet-metal formed part by providing a sheet-metal material having a wall thickness; preforming the sheet-metal material to a semi-finished product as a preform by way of a downholding press, wherein at least one convexity is generated in an internal region of the sheet-metal material such that the material is elongated and has a reduced wall thickness, wherein a downholding element is disposed externally on this region, said downholding element having at least one blocking cam in such a manner that the sheet-metal material is jammed by the downholding element and does not continue to flow in from the outside; flattening and/or spreading the preform thus produced; wherein the sheet-metal material is singularized to a blank before, during, or after preforming; optional trimming and/or perforating of the blank; and forming the blank to the sheet-metal formed part.

The downholding press is provided for producing a semi-finished product from sheet-metal material having thickness-reduced regions, wherein the semi-finished product after forming in the downholding press has regions with mutually dissimilar wall thicknesses. The downholding press has an upper tool and a lower tool. The upper tool and the lower tool can also be referred to as the female die and the male die.

The downholding press furthermore has a downholding element. The downholding element can come to bear on the lower tool. However, the downholding element can also come to bear on a bearing face that is opposite the downholding element and is not part of the lower tool. The sheet-metal holder can also already be part of the lower tool but not directly of the male die. Moreover, the male die and the female die can also be reversed such that the female die is disposed in the lower tool.

A convexity on the sheet-metal material is generated between the upper tool and the lower tool. The convexity requires an increase in length which at the same time requires a reduction in the wall thickness. The region of the sheet-metal material is thus reduced in thickness by way of an elongation. Said region is the region which lies within the downholding element.

According to at least one embodiment it is now provided that a blocking cam is configured on the downholding element per se in such a manner that a follow-on of the sheet-metal material is suppressed.

According to at least one embodiment it is thus provided that the sheet-metal material is jammed and held tight in the region of the downholding element such that a follow-on or a successive feed of the sheet-metal material from a region outside the downholding element is substantially completely suppressed. The wall thickness in the region enclosed by the downholding element, or in the inner region of the sheet-metal material that is enclosed between two downholding elements, respectively, can thus be elongated and thus reduced in thickness in a targeted manner by way of the produced geometry of the convexity.

The blocking cam is configured as a cam or protruding feature, respectively, that projects beyond the downholding element. The blocking cam per se in cross section can be configured so as to be rounded, but also so as to be angular, rectangular or trapezoidal or graduated in multiple steps in cross section. The blocking cam in plan view is configured so as to be linear. The blocking cam can also be configured as an interrupted line. In the case of punctiform blocking cams, a plurality of blocking cams are disposed so as to be distributed beside one another, on one line. In the case of a blocking cam that runs in a linear manner, said blocking cam can run in a straight line. The linear blocking cam can however also run in an arcuate or undulated manner. On account thereof, the blocking effect which prevents a continuing flow of material from the outside can be improved.

In one or more embodiments of the disclosure, a blocking seam is configured on or in a bearing face that lies opposite the downholding element. The blocking seam can be configured in such a manner that said blocking seam has a geometry which is configured so as to be complementary to that of the blocking cam. In the converging of the downholding press the sheet-metal material is thus enclosed and held tight, or fixed or jammed, respectively, between the blocking cam and the blocking seam. The blocking seam in relation to a surface is configured so as to be widened and depressed by the dimension of the sheet-metal thickness.

Alternatively, two blocking cams can also be configured on one bearing face in such a manner that the blocking cam of the downholding element in this instance in the converging engages either in the blocking seam or between the two blocking cams while enclosing the sheet-metal material. An inverse arrangement is likewise conceivable. Two blocking cams are thus configured on the downholding element as well as one blocking cam on the bearing face. In the converging of the downholding press the blocking cam of the bearing face in this instance comes to bear in a form-fitting manner between the two blocking cams of the downholding element, the same applying to blocking cams and blocking seams.

To this end, the blocking cams project by way of less than 10% of the sheet-metal thickness such that the blocking cams penetrate the material at most up to 10% and suppress a continuing flow from the outside. This means, the material lying on the outside has the original wall thickness. After the release of the downholding element, a penetration in the region of the blocking cam is barely noticeable by virtue of the minor penetration depth.

In one or more embodiments of the disclosure, the blocking cam of the downholding element in the open state projects in such a manner that the blocking cam in the closing of the downholding press comes to bear on the sheet-metal material ahead of the upper tool. It can thus be guaranteed in the positioning of the sheet-metal material in the downholding press that the sheet-metal material is first jammed by the blocking cam of the downholding element and is subsequently correspondingly formed and elongated by way of the convexity by further converging the upper tool and the lower tool.

The blocking cam in cross section can furthermore have a rounded contour. This has an advantageous effect on the sheet-metal material in that the latter is not constricted or kinked on the corner regions otherwise present, such that cracks could form here later. Depending on the specific application, the blocking cam in cross section can however also have an angular contour. Fixing or jamming, respectively, in the regions of the corners is performed by way of a high retention force such that a continuing flow of the sheet-metal material is specifically avoided. A hybrid form is configured such that the blocking cam, or blocking seam, respectively, to be generated in the direction of the elongation has an angular contour in cross section, wherein the corner or edge, respectively, that is disposed in the direction toward the elongation is configured so as to be rounded. The highest stress in the direction of traction arises at this corner or edge, respectively, such that any constriction or notch formation, respectively, is avoided. Positive fixing is performed on account of the angular contours of the blocking cam and the blocking seam that are disposed on the side opposite the elongation direction, such that a continuing flow is avoided.

A critical reduction in thickness, or a constriction, respectively, or even bending or kinking of the sheet-metal material is thus avoided specifically in this region.

The disclosure furthermore relates to a method for producing a sheet-metal formed part having mutually dissimilar wall thicknesses. The sheet-metal formed part is used as a motor vehicle component from a steel material or a light-metal material. The method is distinguished by the following features:
providing a sheet-metal material having a consistent wall thickness;
preforming the sheet-metal material to a semi-finished product as a preform by way of a downholding press, wherein at least one convexity is generated in an internal region of the sheet-metal material such that the material is elongated and has a reduced wall thickness, wherein a downholding element is disposed externally on this region, said downholding element having at least one blocking cam in such a manner that the sheet-metal material is jammed by the downholding element and does not continue to flow in from the outside;
flattening and/or spreading the preform thus produced;
wherein the sheet-metal material is singularized to a blank before, during, or after preforming;
optional trimming and/or perforating of the blank; and
forming the blank to the sheet-metal formed part.

The method is carried out on a downholding press described above. In the context of at least one embodiment, a sheet-metal material having a uniformly consistent wall thickness can be used, said sheet-metal material being converted by a method to a so-called tailored blank, consequently to a semi-finished product that is configured so as to be adapted to stress and/or forming. However, it is also possible for a sheet-metal material to be used that already has dissimilar wall thicknesses in cross section or in longitudinal section, so as to achieve by the method according to at least one embodiment a more targeted distribution of thickness and thus a maximum light construction potential in the sheet-metal formed part. In the context of at least one embodiment a so-called tailored extruded blank from a light-metal alloy can also be used as sheet-metal material, said tailored extruded blank being produced according to EP 3 170 570 A1 by extrusion and having dissimilar wall thicknesses in cross section. Said tailored extruded blank is then once more elongated in a localized manner.

In an advantageous refinement of the method it is furthermore provided that a convexity is not only produced in an inner region but rather a plurality of convexities in each case one inner region are produced simultaneously on a preform. These convexities can be configured in opposite directions, for example, but also in the same direction. Further convexities, for example three, four, or more convexities, can also be provided for elongating an inner region. This has an advantageous effect on the subsequent process for producing a blank from the preform.

The process can also be carried out by hot-forming technology and press-hardening technology. To this end, the straightened blank austenitized at least in regions is hot-formed and hardened. It would also be conceivable for the production of the preform to be carried out as at least a semi-hot forming process or a hot-forming process, since the shape-imparting degrees of freedom are enhanced here in the case of a steel alloy that is capable of hardening. Thermal pre-treatment methods in order to achieve corresponding shape-imparting degrees of freedom, or in order to subsequently set desired hardening properties in a targeted manner, respectively, are likewise possible when light-metal alloys are used.

Further advantages, features, properties, and aspects of the disclosure are the subject matter of the description hereunder. One or more of the embodiments will be illustrated in schematic figures.

### BRIEF DESCRIPTION OF THE DRAWINGS

For an understanding of embodiments of the disclosure, reference is now made to the following description taken in conjunction with the accompanying drawings, in which:

FIG. 1 shows the forming process according to the disclosure;

FIG. 2 shows a downholding press according to the disclosure;

FIG. 3 shows a downholding press according to the disclosure, having two downholding elements, in which downholding press two regions of a sheet-metal material are simultaneously reduced in thickness;

FIGS. 4a to 4c show the production process on a downholding press according to FIG. 2;

FIG. 5 shows an embodiment of a downholding press to that of FIG. 1; and

FIGS. 6a to 6c show mutually dissimilar contours of the blocking cam and blocking seam;

FIG. 7 shows blocking cams when engaged on a sheet-metal blank;

FIG. 8 shows a downholding press according to the disclosure;

FIG. 9 shows a detailed view of FIG. 8;

FIGS. 10a and 10b show a preform produced according to the disclosure, as well as the preform after a flattening procedure has been carried out;

FIGS. 11a and 11b show an integral support produced according to the disclosure, having two intermediate regions having a reduced wall thickness; and

FIGS. 12a to 12c show respective downholding elements in plan view.

### DETAILED DESCRIPTION

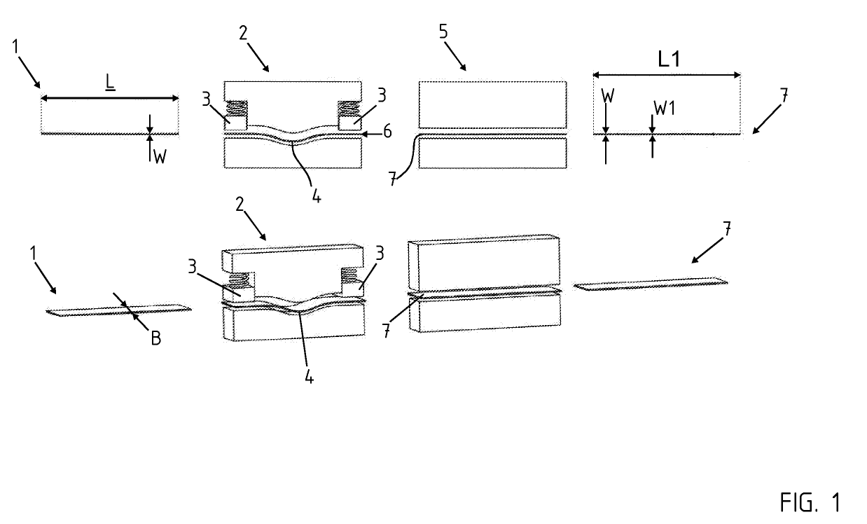

FIG. 1 shows a sheet-metal material 1, in relation to the image plane above in a lateral view and to the image plane below in a perspective view. Said sheet-metal material 1 having a consistent wall thickness W in a first method step is placed into a downholding press 2, wherein the downholding press 2 on two mutually opposite sides has in each case one downholding element 3. By impinging the downholding elements 3 with an increased downholding pressure in relation to a counter bearing, a convexity 4 which leads to an extension in length of the original length L of the sheet-metal material 1 is generated on the sheet-metal material 1 between the upper tool 11 and the lower tool 9 in a further closing. It can be readily seen in the lower image plane that the convexity 4 is configured so as to extend across the entire width B of the sheet-metal material 1. Said convexity 4 can also be configured so as to be only partially across the width B. The material flowing into the length modification requires a reduction in the wall thickness W1 in the region of the convexity 4 in relation to the original wall thickness W, consequently of the initial wall thickness.

In a further method step, a compression forming tool 5 is shown here in which the produced preform 6 is flattened and thus a blank 7 having a central elongated region 16 having a reduced wall thickness W1 is produced. Said blank 7 has a length L1, wherein the length L1 is longer than the length L, and the wall thickness W1 in the elongated region is smaller than the wall thickness W of the original sheet-metal blank 1, said wall thickness W still being present in the respective peripheral region, or in the non-preformed regions of the blank 7, respectively. The flattening is performed as crash forming such that no further centering or adjustment is required. In the shaping to be produced later in a forming tool (not illustrated in more detail here) self-centering in the forming tool can be performed by virtue of the transition in thickness, or else by virtue of the convexity (preform), from the elongated regions having a reduced wall thickness W1 to regions having a regular wall thickness W.

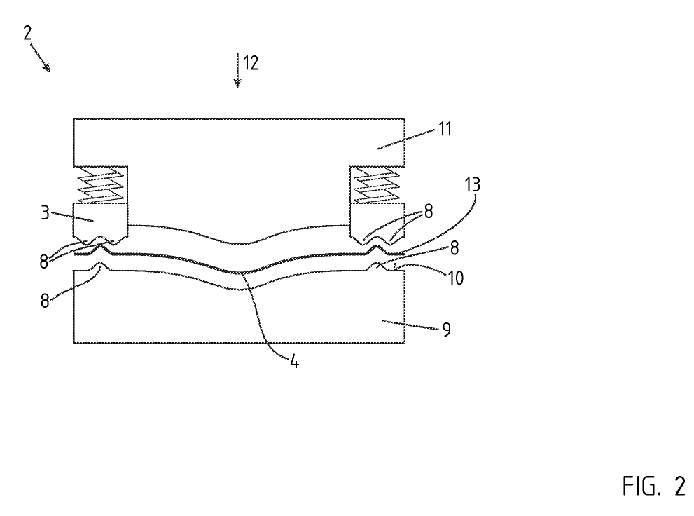

FIG. 2 now shows a downholding press 2 according to the disclosure, in which two blocking cams 8 are disposed in the downholding element 3 per se. A bearing face 10 that lies opposite the downholding element 3 is provided in the lower tool 9, said bearing face 10 likewise having a blocking cam 8. In the closing of the downholding press 2 in the press stroke direction 12 the region of the sheet-metal material 14 initially comes to bear between the blocking cams 8 and is jammed here. Subsequently, a convexity 4 is generated by a respective shape-imparting geometry between the upper tool 11 and the lower tool 9. The sheet-metal material 14 herein in the region of the convexity 4 to be produced is elongated and the wall thickness W1 is reduced herein. A semi-finished product 13 thus produced is likewise illustrated in FIG. 2, or is identified by the reference sign 6 as a preform in FIG. 1, respectively.

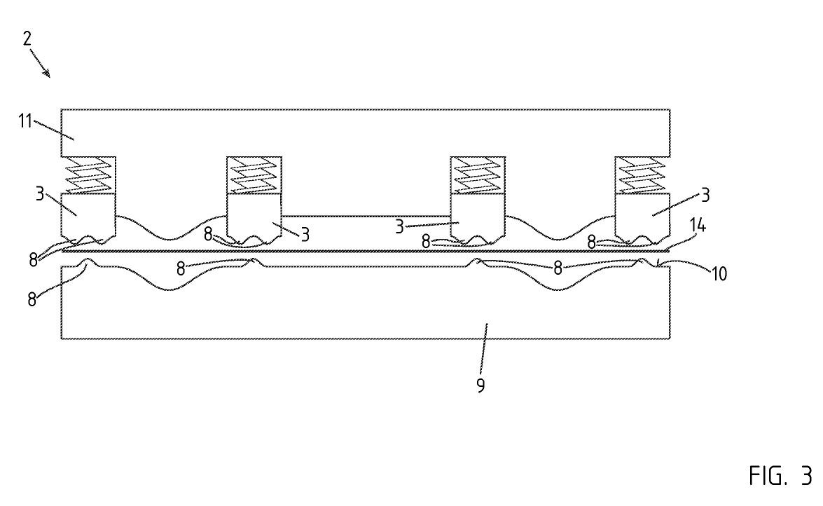

FIG. 3 shows an embodiment, analogous to the construction of FIG. 2, wherein two convexities 4 are simultaneously produced on a sheet-metal material 14 here. A total of four downholding elements 3 are thus configured on the upper tool 11 illustrated here, each having a respective blocking contour. The sheet-metal material 14 in FIG. 1 is identified by the reference sign 1.

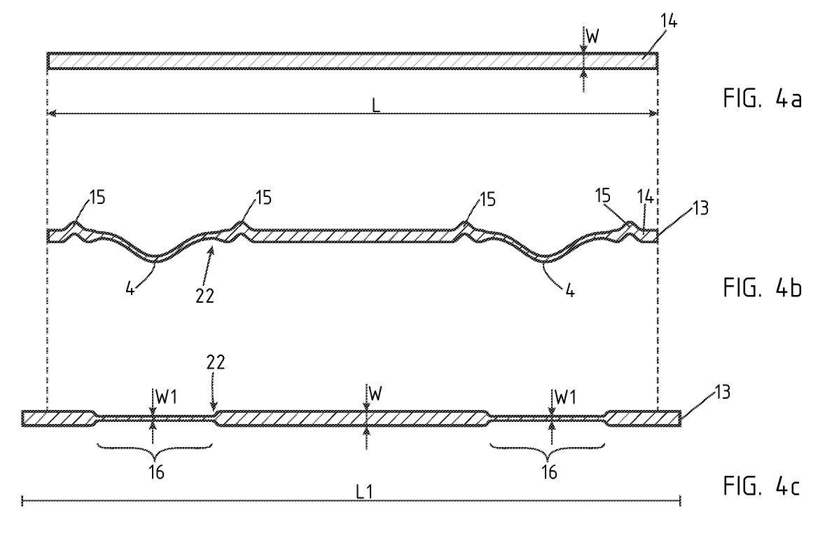

FIGS. 4a to 4c show the production process according to the disclosure on a downholding press according to FIG. 3. A sheet-metal material 14 which has a consistent wall thickness W is first provided. Said sheet-metal material 14 is placed into the downholding press 2 according to FIG. 3. A semi-finished product 13 having two convexities 4, as is shown in FIG. 4b, is subsequently produced. Blocking geometries 15 generated in the peripheral region of the convexity 4 are in each case shown enlarged. Furthermore, a thickness transition region 22 is also present toward the convexity 4 here. In a subsequent flattening or spreading, respectively, of the semi-finished product 13 a blank 7 which has a length L1 which is larger than the length L of the sheet-metal material 14 is then produced, said blank 7 also having regions having mutually dissimilar wall thicknesses. The wall thickness W1 is smaller or thinner, respectively, in relation to the wall thickness W of the sheet-metal material 14. On account thereof, elongated regions 16 having a smaller wall thickness W1 are produced.

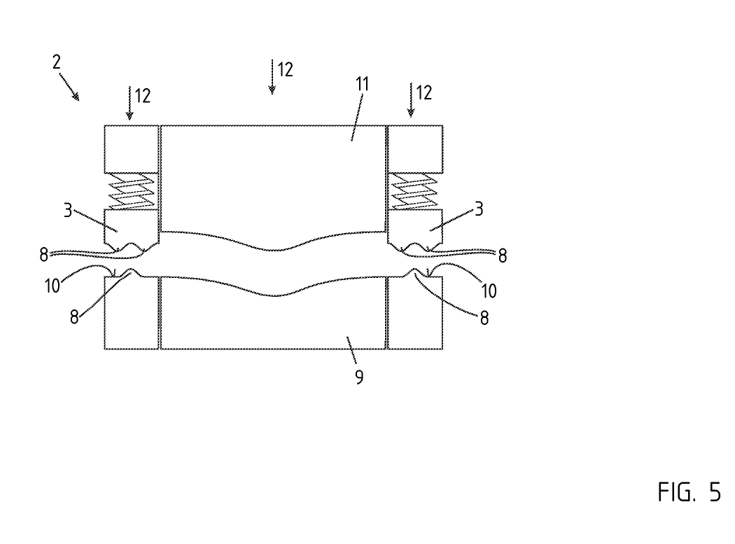

FIG. 5 shows a further embodiment of the downholding press 2 according to the disclosure. The downholding element 3 here is disposed so as to be separate from the upper tool 11 and the lower tool 9. A bearing face 10 on the opposite side of the downholding element 3 is likewise disposed on a separate tool. This offers the advantage that the downholding element 3 in the press stroke direction 12 can be repositioned separately from the upper tool 11. On account thereof, the degrees of freedom in the production of an elongated semi-finished product 13 as a preform are enhanced.

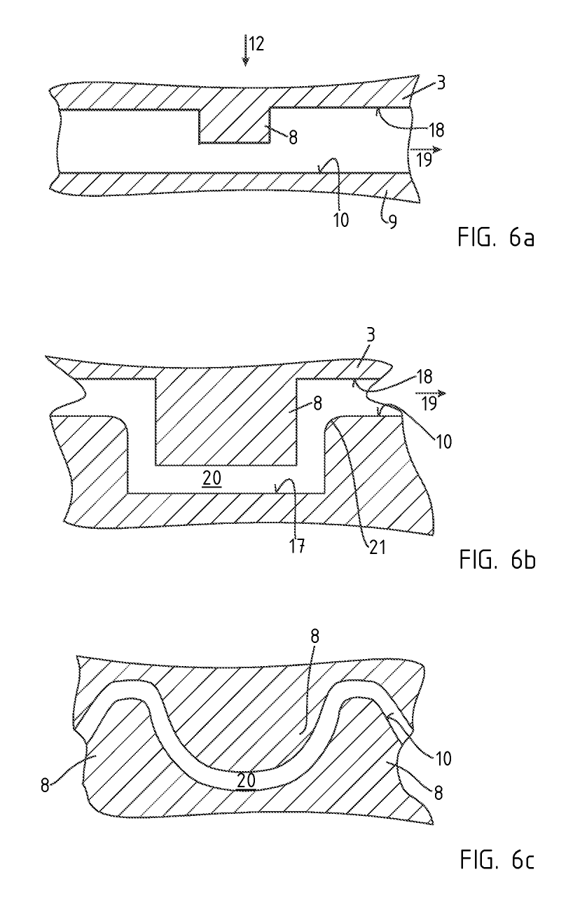

FIGS. 6a to 6c show mutually dissimilar embodiments of the blocking cam 8 according to the disclosure on a downholding element 3. According to FIG. 6a, the blocking cam 8 is configured so as to project in the press stroke direction 12 in relation to the downholding element 3, or to a surface 18 of the downholding element 3, respectively. The blocking cam 8 here comes to bear on a planar bearing face 10, for example of the lower tool 9, while enclosing a sheet-metal material (not illustrated in more detail). The blocking cam 8 consequently is impressed into the sheet-metal material at least in regions and prevents a continuing flow of the sheet-metal material in the elongation direction 19. The elongation direction 19 here is illustrated toward the right in relation to the image plane.

FIG. 6b shows a further embodiment. The blocking cam 8 here is likewise configured so as to project in relation to the surface 18 of the downholding element 3. A blocking seam 17 is configured so as to be depressed in relation to a bearing face 10. The blocking cam 8 in the closed state, as is illustrated in FIG. 6b, thus engages in the blocking seam 17 and forms a mold cavity 20 lying therebetween, in which the sheet-metal material is enclosed. The corner or edge, respectively, that is oriented in the elongation direction 19 is configured as a rounded edge 21. A constriction of the sheet-metal material 14 is avoided on account thereof.

FIG. 6c shows a further embodiment. The blocking cam 8 and the bearing face 10 here are configured as an undulated region. The bearing face 10 per se is likewise configured by two blocking cams 8. Clamping is performed on account of this contour, but there is simultaneously no risk of excessive elongating or kinking arising in the region of a corner.

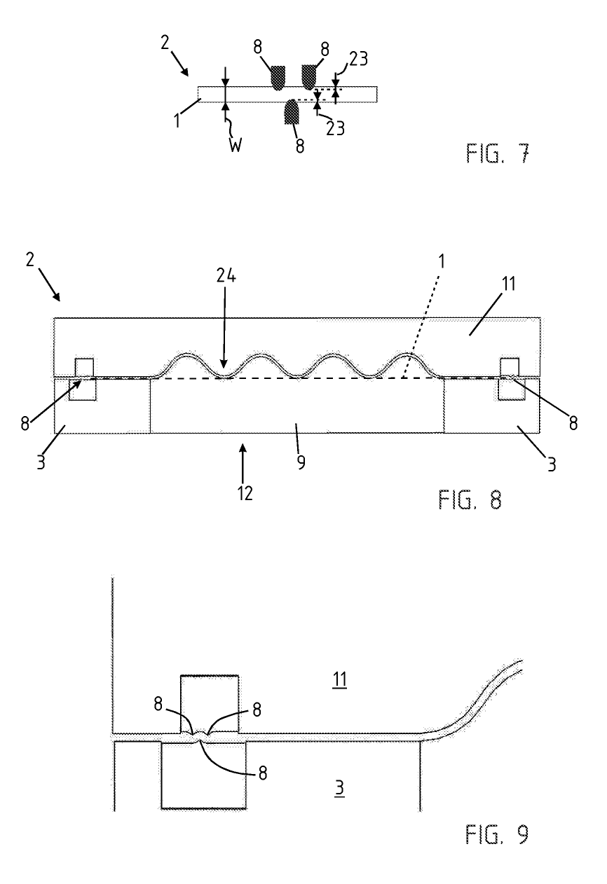

FIG. 7 shows a schematic illustration of a downholding press 2 according to the disclosure. Part of a sheet-metal blank 1 is placed herein, and blocking cams 8 emanating from above and below are disposed. The blocking cams 8 in each case by way of a height 23 or penetration depth, respectively, engage in the sheet-metal blank 1. The height 23 herein is smaller than or equal to 10% of the wall thickness W of the sheet-metal blank 1. Sheet-metal blanks having a wall thickness from 1 to 8 mm can be processed by way of the method according to the disclosure. Sheet-metal blanks having a wall thickness from 1 to 3 mm are processed. Despite the minor penetration depth of the blocking cams 8, a sufficient holding force is however generated, such that a successive feed or a continuing flow, respectively, from the outside is suppressed. Sheet-metal blanks, having a wall thickness of more than 3 mm, can thus also be partially reduced in thickness, for example.

FIG. 8 shows a downholding press 2 according to the disclosure. The downholding press 2 has an upper tool 11 as well as a lower tool 9. Downholding elements 3, also referred to as sheet-metal holders, are disposed on the outside. The blocking cams 8, for example according to FIG. 7, are in each case configured on the left and the right in relation to the image plane. This can be seen in an enlarged illustration in FIG. 9. When a sheet-metal blank 1 is placed therein and the lower tool 9 is still opened in the press stroke direction 12, as is not illustrated here, the sheet-metal blank 1 bears between the upper tool 11 and the downholding element 3. The undulated shape illustrated here of the upper tool 11 for producing convexities on the sheet-metal blank 1 herein do not yet engage in the as yet flat sheet-metal blank 1. If the lower tool 9 is now closed in the press stroke direction 12, the undulated geometry 24 illustrated in FIG. 8 is generated. A successive feed of the sheet-metal blank 1 from the outside is completely suppressed by the blocking cams 8. This means that the region obtained between the blocking cams 8 illustrated on the left side and the right side in FIG. 8 is elongated and on account thereof reduced in thickness by generating the undulated geometry 24 and the convexities associated therewith.

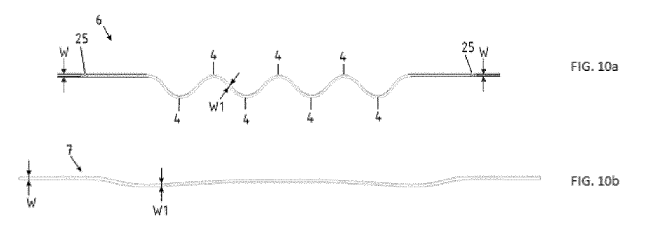

The preform thus produced is illustrated in FIG. 10. Undulated convexities 4 are produced such that a reduced wall thickness W1 is produced here. In each case one embossing 25 by virtue of the blocking cams 8 is present on the left and the right side. This embossing 25 can however be neglected, or concavities or embossings 25 will hardly remain in the case of the flattened blank 7 in FIG. 10b. The original wall thickness W is in each case present outside the embossings 25.

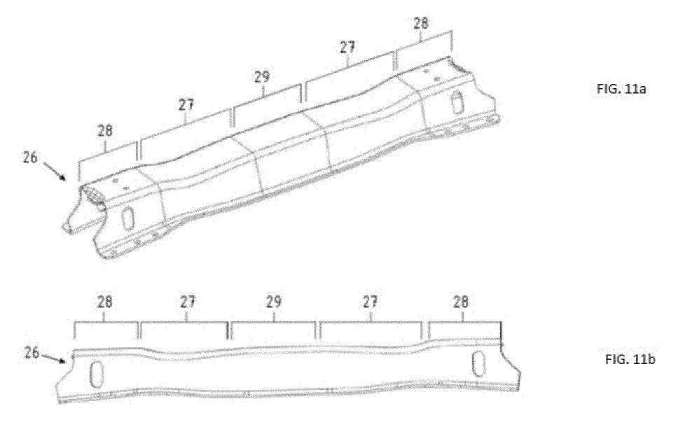

FIGS. 11a and 11b show a component produced according to the disclosure in the form of an integral support, or of a spring bridge 26, which is used in the case of an axle subframe. The spring bridge is illustrated in a perspective view and in a lateral view. This component in cross section is configured so as to be hat-shaped.

Two intermediate portions 27 are configured in the spring bridge 26, wherein the reduced wall thickness is produced in the intermediate portions 27. The original wall thickness is present in a respective end portion 28 as well as in a central portion 29. An elongation by way of blocking cams 8 is carried out herein in a downholding press 2 according to the disclosure, wherein blocking cams 8 are in each case disposed to the left side and to the right side of the intermediate portion 27 such that the wall thickness here is elongated by the convexity and thus reduced in thickness.

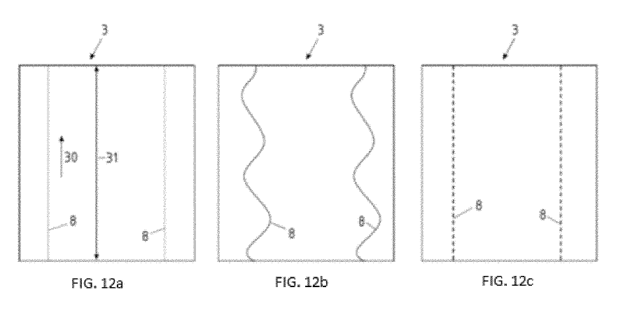

FIGS. 12a to 12c show a respective downholding element 3 in plan view, having blocking cams 8 that run in a linear manner. The blocking cams 8 which, for example in FIG. 7, are shown in cross section are illustrated in a plan view here. In the longitudinal direction 30 of the blocking cams 8 the latter according to FIG. 12a extend in a linear manner as a straight line. The line extends across a depth or width 31, respectively, of the downholding element 3. According to FIG. 12b, the lines can also be configured so as to be undulating or meandering. The effective length of the blocking cam 8 is enlarged on account thereof, and the holding force is in turn increased on account thereof. According to FIG. 12c, it would also be conceivable for the blocking cam 8 in the longitudinal direction 30 thereof to be configured only in portions.

The foregoing description of some embodiments of the disclosure has been presented for purposes of illustration and description. It is not intended to be exhaustive or to limit the disclosure to the precise form disclosed, and modifications and variations are possible in light of the above teachings. The specifically described embodiments explain the principles and practical applications to enable one ordinarily skilled in the art to utilize various embodiments and with various modifications as are suited to the particular use contemplated. It should be understood that various changes, substitutions and alterations can be made hereto without departing from the spirit and scope of the disclosure.

1. A downholding press for producing a semi-finished product from sheet-metal material having thickness-reduced regions, wherein the semi-finished product after forming has regions with mutually dissimilar wall thicknesses, the downholding press comprising:
an upper tool; and
a lower tool; and
a downholding element,
wherein the upper tool and the lower tool are configured to generate a convexity on the sheet-metal material between the upper tool and the lower tool such that the sheet-metal material is reduced in thickness in regions by elongation, and
wherein a blocking cam is configured on the downholding element to suppress a follow-on of the sheet-metal material.

2. A downholding press according to claim 1, wherein
the blocking cam is configured on the downholding element so as to project in relation to the downholding element, and/or
a further blocking cam is configured on the lower tool so as to project in relation to the lower tool.

3. A downholding press according to claim 1, wherein
a blocking seam is configured on or in a bearing face (10) that lies opposite the downholding element, and
the blocking cam of the downholding element in the converging of the downholding press engages in the blocking seam.

4. A downholding press according to claim 1, further comprising:
two further blocking cams configured on a bearing face that lies opposite the downholding element,
wherein the blocking cam of the downholding element in the converging of the downholding press engages between the two further blocking cams while enclosing the sheet-metal material.

5. A downholding press according to claim 3, wherein the blocking cam and the blocking seam have mutually complementary geometries.

6. A downholding press according to claim 1, wherein the blocking cam runs along a straight line or an arcuate line.

7. A downholding press according to claim 1, wherein the blocking cam of the downholding element in a press stroke direction projects to come to bear on the sheet-metal material ahead of the upper tool.

8. A downholding press according to claim 1, wherein the blocking cam in cross section has a rounded contour, or the blocking cam in cross section has an angular contour.

9. A method of producing a sheet-metal formed part having mutually dissimilar wall thicknesses, the method comprising:
providing a sheet-metal material having a wall thickness;
preforming the sheet-metal material to a semi-finished product as a preform by way of a downholding press,
wherein at least one convexity is generated in an internal region of the sheet-metal material such that the material is elongated and has a reduced wall thickness,
wherein a downholding element is disposed externally on the internal region, said downholding element having at least one blocking cam such that the sheet-metal material is jammed by the downholding element and does not continue to flow in from the outside;
flattening and/or spreading the perform, wherein the sheet-metal material is singularized to a blank before, during, or after said preforming; and
forming the blank to the sheet-metal formed part.

10. A method according to claim 9, wherein the at least one convexity comprises
two convexities that are oriented in opposite directions in relation to the original plane of the sheet-metal material, or
two convexities that are oriented in the same direction, or
an undulated shape having a plurality of undulations.

11. A method according to claim 9, wherein
the convexity extends across the entire width of the sheet-metal material, or
the convexity extends across a partial width of the sheet-metal material.

12. A method according to claim 9, wherein the blocking cam engages in the sheet-metal material by a penetration depth which is smaller than or equal to 10% of the wall thickness of the sheet-metal material.

13. A downholding press according to claim 4, wherein the blocking cam and a space between the two further blocking cams have mutually complementary geometries.

14. A method according to claim 9, further comprising:
trimming and/or perforating the blank.
